(19) United States
(12) Patent Application Publication
(10) Pub. No.: US 2021/0191126 A1
(43) Pub. Date: Jun. 24, 2021

(54) PROJECTING IMAGES ONTO A FACE OF A USER

(71) Applicant: Hewlett-Packard Development Company, L.P., Spring, TX (US)

(72) Inventors: Paul Carson, Boise, ID (US); Ian Shatto, Boise, ID (US); Jonathan Neuneker, Boise, ID (US)

(73) Assignee: Hewlett-Packard Development Company, L.P., Spring, TX (US)

(21) Appl. No.: 17/043,356

(22) PCT Filed: Jul. 31, 2018
(86) PCT No.: PCT/US2018/044504

§ 371 Date: Sep. 29, 2020

(51) Int. Cl. G02B 27/01; G10L 15/26; G03B 21/14

(52) U.S. Cl. CPC G02B 27/0172; G02B 2027/0187; G03B 21/14; G10L 15/26

(57) ABSTRACT

A method, according to one example, includes providing a head-mountable apparatus that is wearable on a user's head, and sensing speech of the user while the user is wearing the head-mountable apparatus. The method further includes translating the sensed speech into text, and projecting, with the head-mountable apparatus, images of the text onto the user's face.

### BACKGROUND

An example of an apparatus for displaying images to a user is a head-mounted display system. Head-mounted display systems can be generally referred to as “wearable displays,” because they are supported by a user while in use. Wearable display systems typically include image-generating devices for generating images viewable by the user. Wearable display systems may convey visual information, such as data from sensing devices, programmed entertainment such as moving or still images, and computer generated information. The visual information may be accompanied by audio signals for reception by a user's ears.

### BRIEF DESCRIPTION OF THE DRAWINGS

FIG. 1 is a block diagram illustrating a projection apparatus for use on a user wearable apparatus according to one example.

FIG. 2 is a diagram illustrating a head-mountable apparatus positioned on a user according to one example.

FIG. 3 is a diagram illustrating a side view of the head-mountable apparatus shown in FIG. 2 according to one example.

FIG. 4 is a diagram illustrating a head-mountable apparatus positioned on a user according to another example.

FIG. 5 is a diagram illustrating a side view of the head-mountable apparatus shown in FIG. 4 according to one example.

FIG. 6 is a flow diagram illustrating a method of projecting images onto a face of a user according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Head-mounted display systems or “wearable displays” typically display information to a user or wearer of the display. In contrast, some examples disclosed herein are directed to a wearable head-mounted projector for displaying images on a user's face for viewing by people other than the user. Some examples use depth sensing and/or eye tracking and adjust the position and/or content of the projected images to prevent impeding the user's vision with the projected images. Some examples may detect the location of facial features and project the images on to selected locations of the face determined based on the detected locations of the facial features. The projected images may provide visual effects, such as swirls around the eyes, coloring the skin, altering the appearance of the user, as well as other effects. Some examples incorporate translation technology for translating the user's speech into text that is projected onto the user's face (e.g., forehead).

In some examples, rather than projecting a single static image, the apparatus projects a series of images (e.g., video or animation). Some examples use multiple projectors to allow the series of images to be moved dynamically around the user's face. Some examples use the projected images along with facial recognition technology to provide two factor authentication of the user.

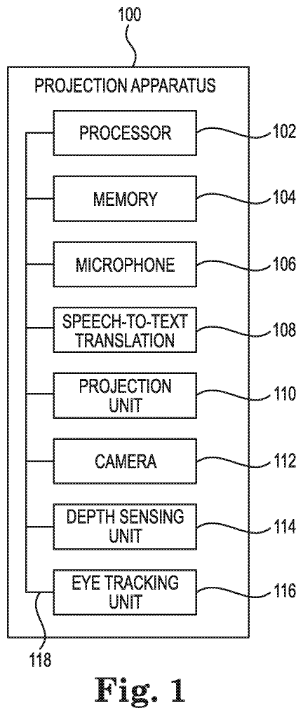

FIG. 1 is a block diagram illustrating a projection apparatus 100 for use on a user wearable apparatus according to one example. Projection apparatus 100 includes at least one processor 102, a memory 104, a microphone 106, a speech-to-text translation unit 108, a projection unit 110, a camera 112, a depth sensing unit 114, and an eye tracking unit 116. In the illustrated example, processor 102, memory 104, microphone 106, speech-to-text translation unit 108, projection unit 110, camera 112, depth sensing unit 114, and eye tracking unit 116 are communicatively coupled to each other through communication link 118.

Processor 102 includes a central processing unit (CPU) or another suitable processor. In one example, memory 104 stores machine readable instructions executed by processor 102 for operating the projection apparatus 100. Memory 104 includes any suitable combination of volatile and/or non-volatile memory, such as combinations of Random Access Memory (RAM), Read-Only Memory (ROM), flash memory, and/or other suitable memory. These are examples of non-transitory computer readable storage media. The memory 104 is non-transitory in the sense that it does not encompass a transitory signal but instead is made up of at least one memory component to store machine executable instructions for performing techniques described herein.

Some or all of the functionality of microphone 106, speech-to-text translation unit 108, projection unit 110, camera 112, depth sensing unit 114, and eye tracking unit 116 may be implemented as machine executable instructions stored in memory 104 and executed by processor 102. Processor 102 may execute these instructions to perform techniques described herein. It is noted that some or all of the functionality of microphone 106, speech-to-text translation unit 108, projection unit 110, camera 112, depth sensing unit 114, and eye tracking unit 116 may be implemented using cloud computing resources.

Microphone 106 senses speech of a user and converts the speech into corresponding electrical signals. Speech-to-text translation unit 108 receives electrical signals representing speech of a user from microphone 106, and converts the signals into text. Speech-to-text translation unit 108 may also translate speech in one language (e.g., Spanish) to text of a different language (e.g., English). Projection unit 110 projects images onto a face of a user. The projected images may include images of the text generated by speech-to-text translation unit 108. Camera 112 captures images of a user's face to facilitate the detection of the locations of the user's facial features (e.g., eyes, nose, and mouth). Depth sensing unit 114 detects the distance between the unit 114 and the user's face, which may be used to facilitate the detection of the locations of the user's facial features. Eye tracking unit 116 tracks the positions of the user's eyes.

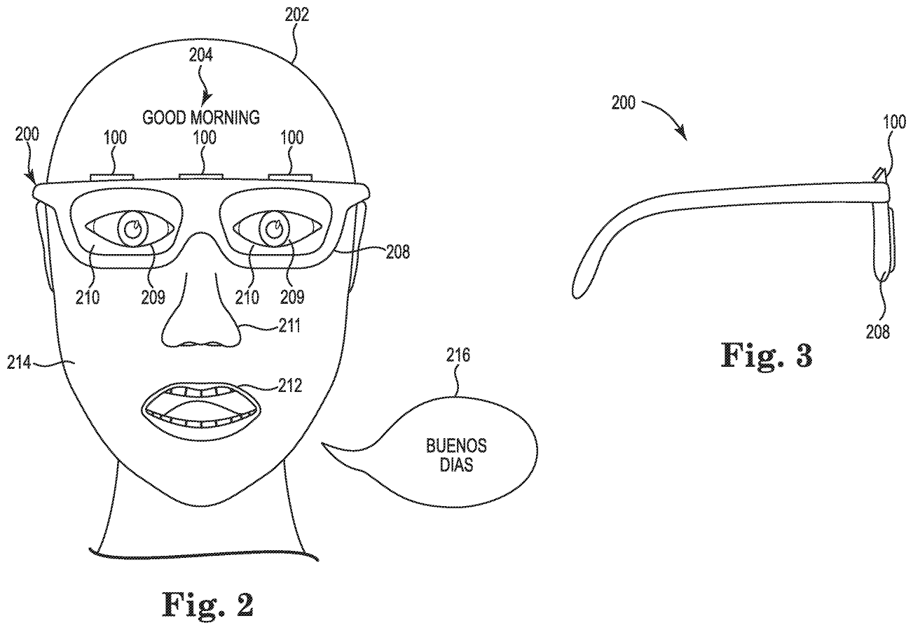

In one example, the various subcomponents or elements of the projection apparatus 100 may be embodied in a plurality of different systems, where different modules may be grouped or distributed across the plurality of different systems. To achieve its desired functionality, projection apparatus 100 may include various hardware components. Among these hardware components may be a number of processing devices, a number of data storage devices, a number of peripheral device adapters, and a number of network adapters. These hardware components may be interconnected through the use of a number of busses and/or network connections. The processing devices may include a hardware architecture to retrieve executable code from the data storage devices and execute the executable code. The executable code may, when executed by the processing devices, cause the processing devices to implement at least some of the functionality disclosed herein. Projection apparatus 100 is described in further detail below with reference to FIGS. 2-5.

FIG. 2 is a diagram illustrating a head-mountable apparatus 200 positioned on a user 202 according to one example. FIG. 3 is a diagram illustrating a side view of the head-mountable apparatus 200 shown in FIG. 2 according to one example. As shown in FIGS. 2 and 3, head-mountable apparatus 200 is an eyeglasses apparatus, and includes a frame 208 supporting two lenses 210. The head-mountable apparatus 200 further includes three projection apparatuses 100. A first one of the projection apparatuses 100 is mounted on the frame 208 directly above a first one of the lenses 210. A second one of the projection apparatuses 100 is mounted on the frame 208 directly above a second one of the lenses 210. A third one of the projection apparatuses 100 is mounted on the frame above the lenses 210 between the first and the second projection apparatuses 100.

Head-mountable apparatus 200 translates speech of the user 202 into text that is projected onto the face 214 of the user 202. As shown in FIG. 2, the user speaks the Spanish words “Buenos dias” as represented by the bubble 216 extending from the mouth 212 of the user 202. At least one of the projection apparatuses 100 of the head-mountable apparatus 200 includes a microphone 106 (FIG. 1) that senses this speech and converts the speech into corresponding electrical signals, which are then converted by speech-to-text translation unit 108 (FIG. 1) into English text (i.e., “Good Morning”). At least one of the projection apparatuses 100 includes a projection unit 110 (FIG. 1) that projects images of the English text onto the face 214 of the user 202. As shown in FIG. 2, an image 204 including the English text “Good Morning” is projected by at least one of the projection apparatuses 100 onto the forehead region of the user's face 214.

Some examples of apparatus 200 may use depth sensing by depth sensing unit 114 (FIG. 1), eye tracking by eye tracking unit 116 (FIG. 1), and/or the capture of facial images by camera 112 (FIG. 1), to locate the position of facial features (e.g., eyes 209, nose 211, mouth 212), and adjust the projected images to, for example, prevent impeding the user's vision with the projected images. Some examples may detect the location of facial features and project the images on to selected locations of the face determined based on the detected locations of the facial features. The projected images may provide visual effects, such as: Swirls in or around the eyes; coloring the skin; providing the appearance of a tattoo or the appearance that the user is wearing makeup; altering the appearance of the user for media creation purposes like plays and television; projecting images on the user's forehead for party games; as well as other effects. Some examples may project arrows on the user's face to show which way the user is going to turn (e.g., when using the system in conjunction with GPS). Some examples may use the projected images along with facial recognition authentication technology to provide two factor authentication. These examples may use a predictably generated image or series of images (i.e., OATH data) in addition to a user's face to provide the two factor authentication as the user's face would be sensed and authenticated, as would the predictably generated image or series of images projected on the user's face.

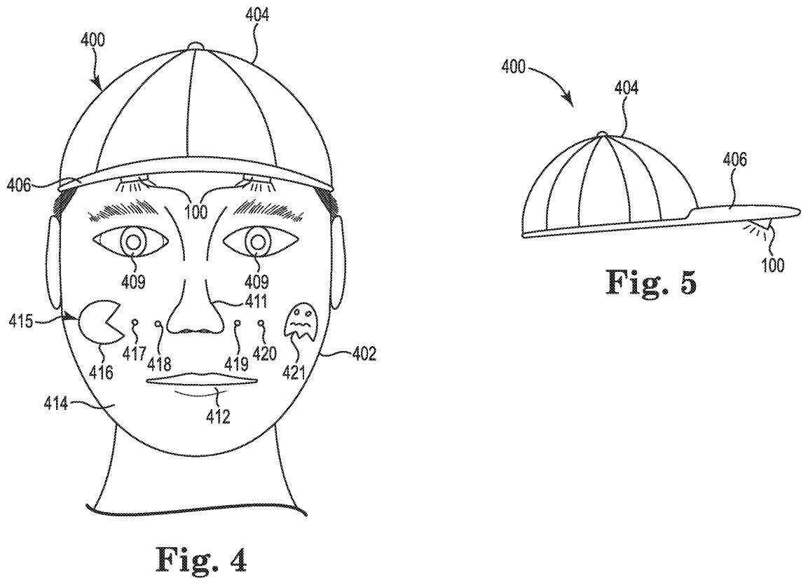

FIG. 4 is a diagram illustrating a head-mountable apparatus 400 positioned on a user 402 according to another example. FIG. 5 is a diagram illustrating a side view of the head-mountable apparatus 400 shown in FIG. 4 according to one example. As shown in FIGS. 4 and 5, head-mountable apparatus 400 is a hat apparatus, and includes a crown 404 that covers the head of the user 402, and a brim 406 that extends outward from the crown 404 above the user's eyes 409. The head-mountable apparatus 400 further includes two projection apparatuses 100. A first one of the projection apparatuses 100 is mounted on a bottom surface of the brim 406 above and in front of a first one of the eyes 409 of the user 402, and a second one of the projection apparatuses 100 is mounted on a bottom surface of the brim 406 above and in front of a second one of the eyes 409 of the user 402.

At least one of the projection apparatuses 100 of the head-mountable apparatus 400 includes a projection unit 110 (FIG. 1) that projects images onto the face 414 of the user 402. As shown in FIG. 4, at least one image 415 including a plurality of image objects 416-421 is projected by at least one of the projection apparatuses 100 onto the cheek regions of the user's face 414. The at least one image 415 may be a single static image, or may be series of images (e.g., a video). The series of projected images may result in at least one of the image objects 416-421 moving across the face 414 of the user 402. Images projected by a first one of the projection apparatuses 100 may partially overlap, completely overlap, or not overlap the images projected by a second one of the projection apparatuses 100. The use of multiple projection apparatuses 100 allows a series of images to be moved dynamically around the user's face 414.

Like apparatus 200, head-mountable apparatus 400 may also translate speech of the user into text that is projected onto the face 414 of the user 402. Some examples of apparatus 400 may use depth sensing by depth sensing unit 114 (FIG. 1), eye tracking by eye tracking unit 116 (FIG. 1), and/or the capture of facial images by camera 112 (FIG. 1), to locate the position of facial features (e.g., eyes 409, nose 411, mouth 412), and adjust the projected images to, for example, prevent impeding the user's vision with the projected images. Some examples may detect the location of facial features and project the images on to selected locations of the face determined based on the detected locations of the facial features. The projected images may provide visual effects, such as: Swirls in or around the eyes; coloring the skin; providing the appearance of a tattoo or the appearance that the user is wearing makeup; altering the appearance of the user for media creation purposes like plays and television; projecting images on the user's forehead for party games; as well as other effects. Some examples may project arrows onto the user's face to show which way the user is going to turn (e.g., when using the system in conjunction with GPS). Some examples may use the projected images along with facial recognition authentication technology to provide two factor authentication. These examples may use a predictably generated image or series of images (i.e., OATH data) in addition to a user's face to provide the two factor authentication as the user's face would be sensed and authenticated, as would the predictably generated image or series of images projected on the user's face.

The head-mountable apparatuses 200 and 400 discussed above are two examples of head-mountable apparatuses that can incorporate at least one projection apparatus 100. Other types of head-mountable apparatuses may also be used to incorporate at least one projection apparatus 100, including, for example, earrings, a tiara, a hijab, or any other apparatus that can be positioned on a user's head.

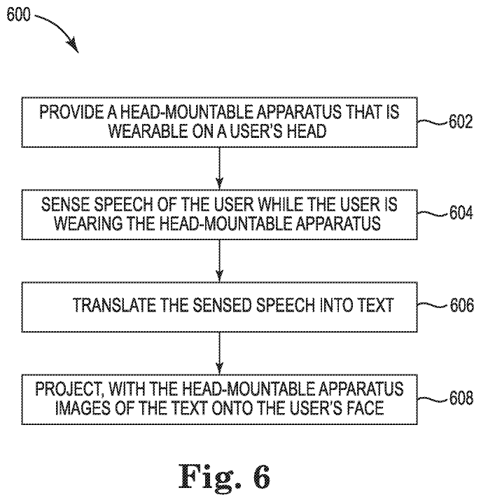

One example is directed to a method of projecting images onto a face of a user. FIG. 6 is a flow diagram illustrating a method 600 of projecting images onto a face of a user according to one example. At 602 in method 600, a head-mountable apparatus that is wearable on a user's head is provided. At 604, speech of the user is sensed while the user is wearing the head-mountable apparatus. At 606, the sensed speech is translated into text. At 608, the head-mountable apparatus projects images of the text onto the user's face.

The text in method 600 may be in a different language than the sensed speech. The method 600 may further include detecting a location of a facial feature of the user; and identifying a position to project the images of the text onto the user's face based on the detected location of the facial feature. The method 600 may further include projecting, with the head-mountable apparatus, the images of the text onto the user's face at the identified position. The head-mountable apparatus in method 600 may project the images of the text onto a forehead region of the user's face.

Another example is directed to an apparatus that includes a head-mountable structure that is wearable on a user's head. The apparatus includes a plurality of projection apparatuses positioned on the head-mountable structure to detect a location of a facial feature of the user, identify a position to project images onto the user's face based on the detected location of the facial feature, and project the images onto the user's face at the identified position.

The head-mountable structure may be a hat. The plurality of projection apparatuses may be positioned on a bottom surface of a brim of the hat. The head-mountable structure may be an eyeglasses apparatus. The eyeglasses apparatus may include a frame supporting two lenses, and the plurality of projection apparatuses may be positioned on the frame. The plurality of projection apparatuses may include three projection apparatuses positioned on the frame above the lenses. The plurality of projection apparatuses may project a predictably generated set of images onto the face of the user, and perform a two factor authentication of the user based on whether the face of the user is present and based on whether the predictably generated set of images is present. The images projected onto the user's face may comprise a video.

Yet another example is directed to an apparatus that includes a head-mountable structure that is wearable on a user's head. The apparatus includes a projection apparatus positioned on the head-mountable structure to sense speech of the user, translate the sensed speech into text, and project images of the text onto the user's face. The head-mountable structure may be one of a hat or eyeglasses.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
providing a head-mountable apparatus that is wearable on a user's head;
sensing speech of the user while the user is wearing the head-mountable apparatus;
translating the sensed speech into text; and
projecting, with the head-mountable apparatus, images of the text onto a face of the user.

2. The method of claim 1, wherein the text is in a different language than the sensed speech.

3. The method of claim 1, and further comprising:
detecting a location of a facial feature of the user; and
identifying a position to project the images of the text onto the user's face based on the detected location of the facial feature.

4. The method of claim 3, and further comprising:
projecting, with the head-mountable apparatus, the images of the text onto the user's face at the identified position.

5. The method of claim 1, wherein the head-mountable apparatus projects the images of the text onto a forehead region of the user's face.

6. An apparatus, comprising:
a head-mountable structure that is wearable on a user's head; and
a plurality of projection apparatuses positioned on the head-mountable structure to detect a location of a facial feature of the user, identify a position to project images onto a face of the user based on the detected location of the facial feature, and project the images onto the user's face at the identified position.

7. The apparatus of claim 6, wherein the head-mountable structure is a hat, and wherein the plurality of projection apparatuses are positioned on a bottom surface of a brim of the hat.

8. The apparatus of claim 6, wherein the plurality of projection apparatuses include at least one of a depth sensing unit and an eye tracking unit to detect the location of the facial feature of the user.

9. The apparatus of claim 6, wherein the head-mountable structure is an eyeglasses apparatus.

10. The apparatus of claim 9, wherein the eyeglasses apparatus includes a frame supporting two lenses, and wherein the plurality of projection apparatuses are positioned on the frame.

11. The apparatus of claim 10, wherein the plurality of projection apparatuses include three projection apparatuses positioned on the frame above the lenses.

12. The apparatus of claim 6, wherein the plurality of projection apparatuses project a predictably generated set of images onto the face of the user, and perform a two factor authentication of the user based on whether the face of the user is present and based on whether the predictably generated set of images is present.

13. The apparatus of claim 6, wherein the images projected onto the user's face comprise a video.

14. An apparatus, comprising:
a head-mountable structure that is wearable on a user's head; and
a projection apparatus positioned on the head-mountable structure to sense speech of the user, translate the sensed speech into text, and project images of the text onto a face of the user.

15. The apparatus of claim 14, wherein the projection apparatus projects a predictably generated set of images onto the face of the user, and performs a two factor authentication of the user based on whether the face of the user is present and based on whether the predictably generated set of images is present.
